(19) United States
(12) Patent Application Publication
(10) Pub. No.: US 2002/0009147 A1
(43) Pub. Date: Jan. 24, 2002

(54) Method, system and apparatus

(76) Inventors: Fabian Edgar Ernst, Eindhoven (NL); Piotr Wilinski, Eindhoven (NL); Cornelius Wilhelmus Antonius Marie Van Overveld, Eindhoven (NL)

Correspondence Address: U.S. Philips Corporation, 580 White Plains Road, Tarrytown, NY, 10591, US

(21) Appl. No.: 09/850,346

(22) Filed: May 7, 2001

(30) Foreign Application Priority Data
May 19, 2000 (EP) 00201774.7

(51) Int. Cl. H04N 7/12

(52) U.S. Cl. 375/240.24; 375/240.01; 375/240.12; 375/240.16

(57) ABSTRACT

In block-based motion or depth estimation, a block is assigned a motion or depth value as a result of minimizing the matching error over a limited set of candidate values (21, 22, 23, 24). The curvature (20) of the function of matching error against candidate value, based on this set, can be used as a measure for the strength of the obtained optimal candidate value for motion or depth. If the obtained value is not sufficiently strong, the method and system according to the invention will repeat the process of determining the optimal candidate value until a sufficiently strong value is obtained. An apparatus for adapting a video signal (40) uses the chosen candidate values to create an enhanced version of the video signal (40).

The invention relates to a method of choosing an optimal candidate value to be used for matching a block from a first image with an area from a second image, the method comprising:

(a) making a set of candidate values for determining an area to be matched from the second image,

(b) for each candidate value from the set, determining an area to be matched from the second image, based on said candidate value, matching the block from the first image with this area and calculating a matching error, and

(c) choosing the optimal candidate value from the set based on the calculated matching errors.

The invention likewise relates to a system for choosing an optimal candidate value to be used for matching a block from a first image with an area from a second image, the system comprising:

a collector, which is arranged for making a set of candidate values for determining an area to be matched from the second image,

a matcher, which is arranged for determining for each candidate value from the set based on said candidate value an area to be matched from the second image, matching the block from the first image with this area and calculating a matching area, and

a selector, which is arranged for choosing the optimal candidate value from the set based on the calculated matching errors.

The invention furthermore relates to an apparatus for processing a video signal that comprises a variety of images.

A method of the type defined in the opening paragraph is known from international patent application published under number WO 99/40726 (PHN 17.017) by the same applicants. With block-based techniques for determining motion and depth in an image, the image is divided into a number of blocks, for example, rectangles of equal size. The image may then be compared with another image by matching the individual blocks in the other image.

Matching a block with a second image is effected by choosing a number of candidate values for the motion vector or the depth and then determining for each candidate value in how far the block corresponds to an area in the second image. The degree of deviation in this match may be calculated. This deviation is called the matching error that belongs to the candidate value. The optimal candidate value is the candidate value that has a relatively small matching error. Suitable candidate values are, inter alia, the depths or the motion vectors of adjacent blocks from the first image, because they are likely to have approximately the same characteristics as the present block. Since a block comprises pixels, the matching error may be determined on the basis of the corresponding pixels in the block from the first image and in the area in the second image. A mathematical technique such as determining the mean square error (MSE) is suitable for this purpose.

A disadvantage of the known method is that it is not established whether the optimal candidate value chosen in accordance with the method described above is accurate enough. When this optimal candidate value is chosen correctly, thus when its matching error matches the real minimum matching error, it is not necessary to repeat the method, although this will happen indeed in the method described above.

It is an object of the invention to provide a method of the type defined in the opening paragraph, in which a better choice for the optimal candidate value is made.

This object is achieved with the method according to the invention in that the steps (a), (b) and (c) are repeated when, as a consequence of a change of the value of the chosen optimal candidate value, a rise of the attendant matching error satisfies a predetermined criterion. This change is a measure for the strength of the chosen optimal candidate value. If the chosen optimal candidate value appears not to satisfy the criterion, this value is not sufficiently strong and the steps (a), (b) and (c) of the method are repeated to determine a stronger optimal candidate value.

In an embodiment of the method the predetermined criterion is a percentage of the matching error of the chosen optimal candidate value. This embodiment is advantageous in that now it is simple to check whether the criterion is satisfied.

In a further embodiment of the method said rise is found by determining an inclination of a curve belonging to a function of matching error plotted against candidate value. The inclination of this curve is a measure for the rise.

In another embodiment of the method the predetermined criterion is a maximum for the inclination of this curve. This embodiment is advantageous in that now it is simple to determine whether the criterion is satisfied.

It is an object of the invention to provide a system of the type defined in the introductory part with which a better choice for the optimal candidate value is made.

This object is achieved with the system according to the invention in that the system is arranged for determining whether, as a result of a change of the value of the chosen optimal candidate value, a rise of the attendant matching error satisfies a predetermined criterion, and is arranged for activating the collector, the matcher and the selector in that case. By activating the collector, the matcher and the selector, a new choice is made for the optimal candidate value. This is only necessary when the previously chosen optimal candidate value is not strong enough, or when it does not satisfy the criterion.

In an embodiment of the system the predetermined criterion is a percentage of the matching error of the chosen optimal candidate value.

In a further embodiment the system is arranged for determining said rise by determining an inclination of the curve belonging to a function of matching error plotted against candidate value.

In an embodiment of the system the predetermined criterion is a maximum for the inclination of this curve.

It is also an object of the invention to provide an apparatus of the type defined in the introductory part, with which a better processing of the video signal is provided.

This object is achieved with the apparatus in accordance with the invention, in that the apparatus comprises:

a system according to the invention for choosing an optimal candidate value to be used for matching a block from a first image with an area from a second image, the system being arranged for choosing optimal candidate values for blocks from the images from said variety, and

an image processor for processing the video signal to obtain an enhanced video signal based on the obtained optimal candidate values as determined by said system.

The image processor enhances the image on the basis of the optimal candidate value that is chosen by a system in accordance with the invention. Since a better choice of the optimal candidate value is made with this system, this will lead to an enhanced image that is better than with other apparatus.

In one embodiment the apparatus further includes a display system for displaying an enhanced video signal.

These and other aspects of the invention are apparent from and will be elucidated with reference to the embodiment(s) described hereinafter.

In the drawings:

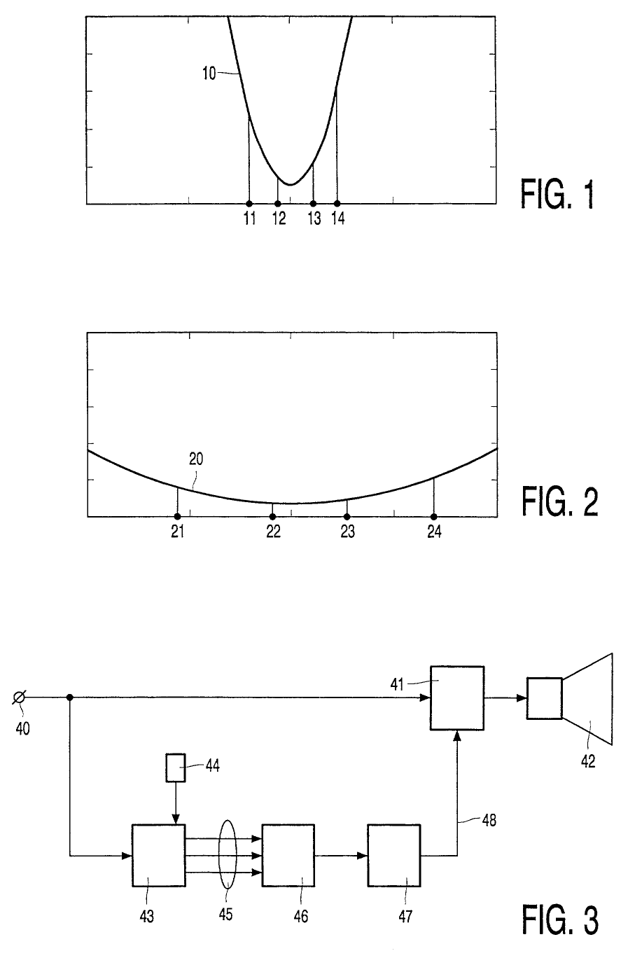

FIG. 1 is a diagrammatic representation of a number of candidate values and their matching errors;

FIG. 2 is a diagrammatic representation of a number of candidate values and their matching errors, and

FIG. 3 is a diagrammatic representation of an apparatus according to the invention for processing an image.

In block-based techniques for determining motion and depth in a first image, the image is subdivided into a number of blocks. These blocks may be rectangular and of equal size, so that the subdivision may be effected in a simple and fast manner, although it is alternatively possible to utilize arbitrary other shapes. The use of non-rectangular blocks is advantageous in that now arbitrary objects may be covered by a group of blocks, so that motion or depth of such an object can be determined. By subdividing the image into blocks, it is now possible to compare the image with a second image by matching the blocks from the first image with an area from the second image. If the blocks are chosen sufficiently small, there may be assumed that each block moves uniformly and that the depth in a block is the same everywhere. It is then possible to look for an area from the second image that corresponds to a block from the first image. If this is found, the shift of this block in between the two images may be determined and thus the motion of this block. If the two images both relate to a still object, this provides the information that is necessary for determining the depth of this object.

Rarely will it happen that a block from the first image fully matches an area from the second image. This problem is solved by determining, on the basis of the candidate value for the depth or for the motion vector, where the block from the first image would have to be situated in the second image. Subsequently, the area from the second image corresponding to this is matched with the first block and the degree of deviation of the match may be calculated. This deviation is called the matching error of the candidate value. The optimal candidate value is the candidate value having a relatively small matching error, preferably the smallest matching error.

Since a block consists of pixels, the matching error may be determined on the basis of the corresponding pixels in the two blocks. A mathematical technique such as determining the mean square error (MSE) is suitable for this purpose. With this technique the matching error for a motion vector (dx, dy) can be calculated as follows:

$$MSE ( i , j ) = {\sum }_{m = 1}^{M} {\sum }_{n = 1}^{N} {[ {U}_{1} ( m , n ) - {U}_{0} ( m + dx , n + dy ) ]}^{2}$$

Herein M and N are the dimensions of the block in pixels and U₁(m, n) is the pixel intensity in image i at location (m, n). Calculating the matching error for a depth d takes place in similar manner.

Another suitable mathematical technique is calculating the sum of absolute differences (SAD). The matching error for a depth d may be calculated herewith as follows:

$$SAD ( d ) = {\sum }_{( x , y ) ∈ B} \vert {U}_{1} ( x + Δ x ( d ) , y + Δ y ( d ) ) - {U}_{0} ( x , y ) \vert$$

Herein, (x, y) is a pixel in a block B and Δx(d) is the change of x based on the candidate value for the depth d.

In addition to the mean square error and the sum of absolute differences, also other mathematical techniques, such as the mean absolute difference or the sum of square errors may be used for calculating the matching error of a candidate value for the depth or for a motion vector.

For practical reasons, inter alia, because there is only little time to process a separate image during video signal processing, usually a set of a limited number of candidate values is made, which are subsequently used, as described above, for determining an area from the second image, after which the block from the first image is matched therewith. It is common practice that the values for the depth or the found motion vector of adjacent other blocks are chosen, possibly added by a random value or a previously calculated value for the depth or the motion vector for this block. After the matching errors of the elements of the set have been calculated, the optimal candidate value is chosen as the candidate value having the smallest matching error.

The steps of making the set, calculating the matching errors of the elements of this set and choosing the optimal candidate value may be executed as three separate steps, but also in combination. For each chosen candidate value the matching error may be calculated directly, for example, after which this matching error can be compared with a “running minimum”. If a matching error that has just been calculated turns out to be smaller than this running minimum, the current candidate value is chosen as a provisional optimal candidate value and its matching error as a new running minimum. After all the candidate values in the set have been chosen, the thus determined provisional optimal candidate value now becomes the real optimal candidate value.

The method described above may be repeated a number of times to come to the best possible choice of the optimal candidate value. In the case where the depth in the image is determined, initially the depths are chosen at random. With each repetition the values of adjacent blocks are used then, which values may be different from the values of the previous repetition. The newly found value having the smallest matching error is subsequently used for calculating the matching error of other blocks. When the values no longer change, the final value is determined and repetitions may be stopped. With each repetition, the current value for the optimal candidate value and the matching error are to be saved for each block.

FIG. 1 shows a graph in which the matching error is plotted as a function of the candidate value for a block depth. There are a number of candidate values 11, 12, 13 and 14 on the x-axis with their matching errors in a curve 10. The approximation of the curve 14 becomes better as more and more candidate values 11, 12, 13 and 14 are used. The real minimal matching error lies in the curve 14 between candidate values 12 and 13 and forms the minimum of the curve 10. Candidate value 12 may now be chosen as the optimal value because it has the lowest matching error of all the candidate values 11, 12, 13 and 14.

When the graph relates to depth candidate values, the smallest depth values are minimums of the curve 10. With candidate values for motion vectors, each candidate value is a vector having components for the horizontal and vertical motion. In that case a motion vector candidate value is a minimum of the curve 10 when one of the components of this vector is smaller than the corresponding components of the other vectors.

FIG. 2 shows a second graph in which the matching error is plotted as a function of the depth candidate value. On the x-axis of the graph there are a number of candidate values 21, 22, 23 and 24 with their attendant matching errors in a curve 20. Candidate value 22 may now be chosen as the optimal value, because it has the lowest matching error of all the candidate values 21, 22, 23 and 24. The curve 20, however, rises less than the curve 10 of FIG. 1 for the same change of value of a candidate value. This change is a measure for the “strength” of the chosen optimal candidate value. According to this measure, the candidate value 22 is a weak optimal candidate value, whereas candidate value 12 of FIG. 1 is a strong optimal candidate value.

It is now possible to utilize the strength as a criterion for determining whether a chosen optimal candidate value is acceptable. On the basis hereof there may be determined whether the method described above of selecting an optimal candidate value is to be repeated to make a better choice. If the chosen optimal candidate value is strong enough, a repetition of the method will yield the same optimal candidate value. So this method only needs repeating if the result is a weak optimal candidate value.

A possible criterion for determining the strength is a percentage of the matching error of the chosen optimal candidate value. This percentage then denotes that a candidate value must not be more than an integral or partial number of times more than the optimal candidate value 22. This may be used, for example, by determining an interval around the optimal candidate value 22, within which a candidate value is no more than a number of times the value of the optimal candidate value 22. If this percentage is chosen to be fixed, the width of this interval is a measure for the strength: the larger the interval, the weaker the optimal candidate value. The width may also be pre-chosen to be fixed and the percentage determined at which this width is achieved: the larger this percentage, the stronger the optimal candidate value.

If sufficient candidate values 21, 23 and 24 are determined in the neighborhood of the optimal candidate value 22, the inclination of the curve 20 around the optimal candidate value 22 may be determined, for example, via a technique such as interpolation or the mean square error technique. So doing, the rise of the matching error as a consequence of a change of the value of the chosen optimal candidate value 22 may be determined. If this inclination satisfies a certain criterion, for example, if this inclination is less than a certain number of degrees, the optimal candidate value is not strong enough and a new optimal candidate value can be determined.

An alternative to the techniques described above is the storage of all the candidate values 21, 22, 23 and 24 with their corresponding matching errors. At a later stage the curve 20 can always be determined with them. Since relatively many candidate values are necessary for this technique, a relatively large amount of storage capacity is necessary.

FIG. 3 represents an apparatus for processing a video signal 40, which video signal 40 comprises a variety of images. The apparatus comprises an image processor 41, which is arranged for processing the video signal 40 to obtain an enhanced video signal. This enhanced video signal is then displayed on a display system 42. Although FIG. 3 shows the display system 42 as part of the same apparatus that includes the image processor 41, it may be clear that the display system 42 may also be arranged independently of the apparatus and can receive the enhanced video signal from the apparatus, for example, via a network.

The image processor 41 can enhance the video signal 40 based on information about the motion or depth of individual images in the video signal 40. For example, it is possible for the image processor 41 to process the video signal 40, so that a user can watch the image from another angle by separately rotating, based on depth information, individual objects determined by a group of blocks, and thus generating a correct reproduction from another angle. This may provide, for example, a stereoscopic reproduction. Motion information may be used for detecting and marking moving objects, for example, to be used for automatic surveillance cameras. The thus obtained video signal with marked objects provides an enhancement for the user of these cameras, because they can now detect the image changes much faster.

In another possible application the image processor 41 enhances the video signal 40 which is offered, for example, in a compressed format such as MPEG, by producing a video signal that is compressed more efficiently. An individual object determined via a group of blocks, which object occurs in a number of images in the video signal 40, may now be compressed by storing pixel information about the object once-only and storing only the motion vector or depth information of this object for other images this object occurs in. Since this information requires less storage capacity than the pixel information of the complete object, a method such as this one can provide a considerably enhanced compressed video signal.

For clarity, the explanation below is about the function of elements of the system only when a first block depth is determined, but it may be clear from the above that the movement of a first block can be determined in similar manner.

The apparatus further includes a collector 43, a matcher 46 and a selector 47. The collector 43 is arranged for making a set 45 of candidate values for determining an area to be matched from the second image. The set 45 made by the collector 43 includes, inter alia, previously determined depths of blocks adjacent to the first block. The depths of adjacent blocks will generally show little mutual difference. The depths of blocks adjacent to the first block therefore form a good starting point for determining the depth of the first block and are therefore used as candidate values for this depth. To this end there is a storage system 44 on which this depth and other previously determined depths can be stored, so that the collector 43 can use them when making the set 45 of candidate values.

The collector 43 sends the set 45 of candidate values on to a matcher 46. The matcher 46 determines for each candidate value from the set, on the basis of said candidate value, an area to be matched from the second image. Subsequently, the matcher 46 matches the block from the first image with this area and the matcher 46 calculates an associated matching area, as is described above. For this purpose, methods mentioned earlier may be implemented, such as the mean square error, the mean absolute difference, the sum of absolute differences or the sum of square errors.

After the matching errors of the candidate values from the set 45 have been calculated, a selector 47 chooses the optimal candidate value 48 from the set 45 on the basis of the calculated matching errors. The optimal candidate value 48 is the candidate value having a relatively low matching error. The selector 47 then sends the optimal candidate value 48 to the image processor 41. Repeating this procedure for various blocks from an image provides depth information for this image. Based on the thus provided depth information, the image processor 41 can process the video signal 40 to obtain an enhanced video signal. This enhanced video signal may then be displayed on the display system 42.

The system is arranged for determining whether, as a consequence of a change of the value of the chosen optimal candidate value, a rise in the attendant matching error satisfies a predetermined criterion. This determines, as described above with reference to FIG. 2, the strength of the chosen optimal candidate value. The system thus determines whether the chosen optimal candidate value is sufficiently strong. A criterion for the strength is, for example, a percentage of the matching error of the chosen optimal candidate value.

If the chosen optimal candidate value is not strong enough, the system activates the collector 43, the matcher 46 and the selector 47. Then they choose in the manner described above a new optimal candidate value whose strength can also be determined, as desired. If this strength is not enough either, the system can activate the collector 43, the matcher 46 and the selector 47 once more. If the chosen optimal candidate value is strong enough indeed, it is not necessary to choose a new optimal candidate value once more.

The system can determine said rise by determining an inclination of a curve belonging to a function of matching error plotted against candidate value. The predetermined criterion is then preferably a maximum for the inclination of this curve.

1. A method of choosing an optimal candidate value to be used for matching a block from a first image with an area from a second image, the method comprising:
(a) making a set (45) of candidate values (11, 12, 13, 14) for determining an area to be matched from the second image,
(b) for each candidate value from the set (45), determining an area to be matched from the second image, based on said candidate value (11, 12, 13, 14), matching the block from the first image with this area and calculating a matching error, and
(c) choosing the optimal candidate value (12) from the set (45) based on the calculated matching errors, characterized in that the steps (a), (b) and (c) are repeated when, as a consequence of a change of the value of the chosen optimal candidate value (12), a rise of the attendant matching error satisfies a predetermined criterion.

2. A method as claimed in claim 1, characterized in that the predetermined criterion is a percentage of the matching error of the chosen optimal candidate value (12).

3. A method as claimed in claim 1, characterized in that said rise is found by determining an inclination of a curve (10) belonging to a function of matching error plotted against candidate value.

4. A method as claimed in claim 3, characterized in that the predetermined criterion is a maximum for the inclination of this curve (10).

5. A system for choosing an optimal candidate value to be used for matching a block from a first image with an area from a second image, the system comprising:
a collector (43), which is arranged for making a set (45) of candidate values (11, 12, 13, 14) for determining an area to be matched from the second image,
a matcher (46), which is arranged for determining for each candidate value from the set (45) based on said candidate value (11, 12, 13, 14) an area to be matched from the second image, matching the block from the first image with this area and calculating a matching area, and
a selector (47), which is arranged for choosing the optimal candidate value from the set (45) based on the calculated matching errors,
characterized in that the system is arranged for determining whether, as a result of a change of the value of the chosen optimal candidate value, a rise of the attendant matching error satisfies a predetermined criterion, and is arranged for activating the collector (43), the matcher (46) and the selector (47) in that case.

6. A system as claimed in claim 5, characterized in that the predetermined criterion is a percentage of the matching error of the chosen optimal candidate value (12).

7. A system as claimed in claim 5, characterized in that the system is arranged for determining said rise by determining an inclination of the curve (10) belonging to a function of matching error plotted against candidate value.

8. A system as claimed in claim 7, characterized in that the predetermined criterion is a maximum for the inclination of this curve (10).

9. An apparatus for processing a video signal (40) that comprises a variety of images, including:
a system (43, 46, 47) as claimed in claim 5, 6, 7 or 8 for choosing an optimal candidate value (48) to be used for matching a block from a first image (40) with an area from a second image, the system being arranged for choosing optimal candidate values for blocks from the images from said variety, and
an image processor (41) for processing the video signal (40) to obtain an enhanced video signal based on the obtained optimal candidate values as determined by said system (43, 46, 47).

10. An apparatus as claimed in claim 9, characterized in that the apparatus further includes a display system (42) for displaying the enhanced video signal.
